(19) United States
(12) Patent Application Publication
(10) Pub. No.: US 2018/0256426 A1
(43) Pub. Date: Sep. 13, 2018

(54) Neonatal Incubator System with X-Ray Viewing Panel

(71) Applicant: General Electric Company, Schenectady, NY (US)

(72) Inventor: Vinayaka N, Bangalore (IN)

(73) Assignee: General Electric Company, Schenectady, NY (US)

(21) Appl. No.: 15/455,351

(22) Filed: Mar. 10, 2017

(51) Int. Cl. A61G 11/00

(52) U.S. Cl. CPC A61G 11/009; A61G 2210/50; A61G 11/001

(57) ABSTRACT

A neonatal incubator system includes a platform for supporting a neonate, a canopy defining an area above the platform, the canopy having at least two vertical walls extending generally perpendicularly with respect to the platform and a hood that extends above the platform. An x-ray viewing panel is provided on the hood of the canopy, wherein the x-ray viewing panel is illuminable to view x-ray film, and a light source that illuminates the x-ray viewing panel.

### BACKGROUND

The present disclosure relates to an infant care apparatus. More specifically, the present disclosure relates to incubator systems.

An incubator system is used in the care of infants, particularly neonates, in order to provide a controlled environment within which the infant is contained to promote the wellbeing of the infant. The incubator system defines a microenvironment that surrounds the neonate. Thereby, the incubator system operates to control environmental conditions of the microenvironment, such as oxygen, temperature, humidity, and light in such a manner as to promote the health and wellbeing of the infant patient. An incubator may also provide a physical or other environmental barrier such that the microenvironment is sterile or partially sterile in order to reduce the risks of infection to the neonate.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In one embodiment, a neonatal incubator system includes a platform for supporting a neonate, a canopy defining an area above the platform, the canopy having at least two vertical walls extending generally perpendicularly with respect to the platform and a hood that extends above the platform. An x-ray viewing panel is provided on the hood of the canopy, wherein the x-ray viewing panel is illuminable to view x-ray film, and a light source that illuminates the x-ray viewing panel.

One embodiment of a hood for a canopy of an incubator is provided, wherein the canopy encloses an area above a platform that supports a neonate and the canopy has four vertical walls extending generally perpendicularly with respect to the platform. The hood includes a flat top side that is generally horizontal and extends above the platform, wherein the flat top side is surrounded by an edge. Four side portions connect between the edge of the flat top side and a connecting lip configured to removably connect to the vertical walls of the canopy. An x-ray viewing panel is provided on the hood of the canopy, the x-ray viewing panel being illuminable by a light source to view x-ray film.

Various other features, objects, and advantages of the invention will be made apparent from the following description taken together with the drawings.

### BRIEF DESCRIPTION OF THE DRAWINGS

The present disclosure is described with reference to the following Figures.

FIG. 1 is an exemplary embodiment of an incubator system having an x-ray viewing panel.

FIG. 2 is another exemplary embodiment of a neonatal incubator system having an x-ray viewing panel.

FIG. 3 depicts an embodiment of a canopy of an incubator system having one embodiment of an x-ray viewing panel

FIG. 4 depicts the canopy of FIG. 3 having another embodiment of an x-ray viewing panel.

FIG. 5 depicts one embodiment of a hood for an incubator system having one embodiment of an x-ray viewing panel.

FIG. 6 provides a cross-sectional view of another embodiment of a hood for an incubator having an x-ray viewing panel.

FIGS. 7A and 7B depict exemplary hoods for incubator systems comprising differing embodiments of x-ray viewing panels.

### DETAILED DESCRIPTION

The inventor has recognized that neonatal care clinicians are burdened because they are unable to examine x-ray films in the presence of the neonate patient 82, and thus are unable to examine the neonate 82 simultaneously with looking at the x-rays. For example, the clinician may wish to view the x-ray results and the baby during investigation, or may wish to quickly review the x-rays while doing reporting at the location of the incubator system housing the neonate 82. Typically, x-ray viewers for viewing x-ray film are located in a different location from the incubator housing the neonate 82. Thus, the clinician is unable to analyze the x-ray film in front of the baby, and thus unable to examine the baby and the x-ray film simultaneously unless the clinician is able to move the incubator into proximity of the x-ray viewer. This typically is not possible since removing the baby from the incubator environment is not advised and since most incubators are large, powered devices that are difficult to transport for such purposes.

Upon recognition of the foregoing problems and needs in the relevant industry, the inventor developed the disclosed incubator system having an x-ray viewing panel on the canopy that defines the microenvironment around the neonate. For example, the x-ray viewing panel 40 may be on the hood 20 of the canopy 6. The x-ray viewing panel is illuminable to view x-ray films, such as selectively illuminable by the clinician operating a user interface to turn on a light source that illuminates the x-ray viewing panel. As described herein, the x-ray viewing panel 40 may be incorporated into the construction of the hood 20, permanently fixed to the hood 20, or may be a moveable accessory configured to be placed on the hood 20 when the clinician 80 wants to view x-ray films in the presence of the neonate 82. To provide just one example, the x-ray viewing panel may be a light diffuser 46 that diffuses light from a light source comprised of one or more LEDs. In certain examples disclosed herein, the light diffuser 46 is incorporated into the construction of the hood 20. In other examples, the light diffuser 46 is a flexible sheet comprised of a light diffuser film product that breaks up and evenly distributes light from a light source.

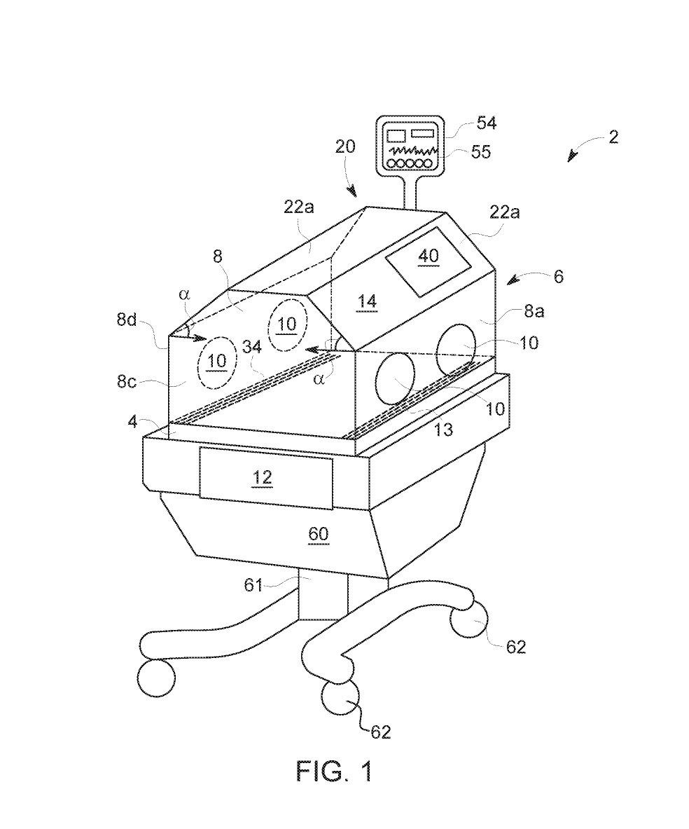

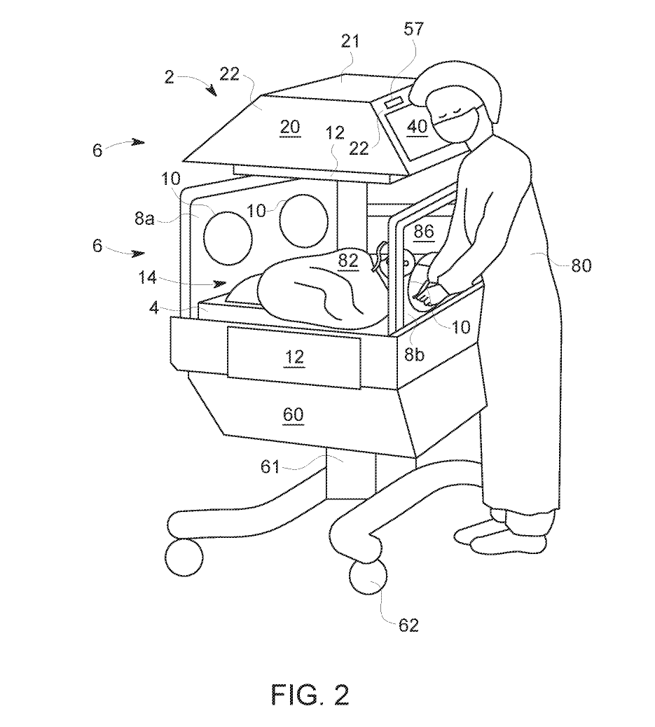

FIGS. 1 and 2 depict environmental views of incubator systems 2 providing microenvironments 14 for neonates 82. The incubator systems include a mobile pedestal 61 on wheels 62 that can be moved about a medical care facility, such as to and from a neonatal intensive care unit (NICU) to various care centers within a medical facility. In certain embodiments, the incubator system 2 may be physically and/or communicatively connected to a NICU workstation that in certain embodiments provides additional functionality and data connections. In certain embodiments, two or more incubator systems 2 may be connected to a single NICU workstation.

The incubator system 2 includes a platform 4 providing a horizontal, or generally horizontal, surface for supporting a neonate 82. However, it is to be understood that the platform 4 within the incubator system 2 may have the ability to or be controllable to move, rotate, or incline the platform 4. Two or more walls 8 extend generally vertically from the platform 4 and a hood 20 extends over the platform 4. The vertical walls 8 and hood 20 form a canopy 6 that defines an area above the platform 4 in which the microenvironment is maintained. In the embodiment depicted in FIG. 1, the canopy 6 has four vertical walls 8a-8d extending generally perpendicularly and vertically upwards around the platform 4 to define a rectangular shape. However, it will be understood that in alternative embodiments, various numbers of vertical walls 8 may be used to define the canopy 6, and thus the microenvironment enclosing the neonate. Another example is provided by FIG. 2, where the canopy 6 includes two vertical walls 8a, 8d extending upwards from either longitudinal side of the platform 4. In still other embodiments, the canopy may be curved, rounded, or domed in shape.

In the embodiment depicted in FIG. 1, the canopy 6 is comprised of an integrally connected hood 20 and set of vertical walls 8a-8d. However, in other embodiments, the canopy 6 may be comprised of separate elements, such as separate vertical walls 8 and/or hood 20 that may be connectable or may be separate elements connected to the incubator system 2 and may not actually contact one another. For example, in the embodiment of FIG. 2, the hood 20 is a separate element suspended above the vertical walls 8a, 8d. For example, the hood 20, such as in FIG. 2, may be vertically adjustable or moveable with respect to the vertical walls 8 in order to assist in controlling the microenvironment 14. One or more of the vertical walls 8a-8d may further include arm ports 10 that permit a clinician 80 access to the microenvironment 14, but minimize heat loss and/or contamination from the outside environment to the microenvironment.

The canopy 6 defines a microenvironment 14 above the platform 4 such that the environmental conditions surrounding the neonate 82 are controlled. Accordingly, the incubator system 2 includes one or more environmental modification elements 12, such as a heater and/or humidifier. In the embodiment of FIG. 1, the environmental modification elements 12 are housed in a base 60 below the platform 4. Communication between the environmental modification elements 12 and the microenvironment 14 are provided through vents 13 in and around the platform 4. In other embodiments, communication between the environment modification elements 12 and the microenvironment 14 may be by other means to control the conditions within the microenvironment 14. FIG. 2 depicts an embodiment where at least some of the environment modification elements 12 are provided in the hood 20. For example, the hood 20 may house a heater, such as a radiant heater, that operates to control the temperature of the microenvironment 14.

The hood 20 generally defines a top portion of the microenvironment 14, such as providing a roof for the microenvironment 14. The hood 20 may be any shape, including flat, or horizontal, angled, rounded, etc. In a preferred embodiment, the hood 20 comprises one or more flat surfaces upon which an x-ray viewing panel 40 is located. In the examples of FIGS. 1 and 2, the hood 20 comprises a flat top side 21 and at least two side portions 22. In various embodiments depicted herein, the side portions 22 may be positioned anywhere between a vertical position, such as in line with the vertical wall 8. Or provided at an angle between 0° and 90° from horizontal. In the embodiment depicted in FIG. 1, the side portions 22 are angled side portions 22a provided at angle alpha with respect to the horizontal axis parallel with the platform 4, or alternatively at an angle greater than 90° and less than 180° from the respective vertical wall 8.

In the embodiment depicted in FIG. 1, the incubator system 2 includes a digital display 54 operated by a controller (not depicted) to present a graphical user interface (GUI) 55. For example, the digital display 54 may be a touch-sensitive graphical display (a touchscreen) and the GUI 55 configured to respond to inputs made by a clinician 80 received through the touch-sensitive input element on the digital display 54. Thereby, the digital display 54 and touch-sensitive configured GUI 55 can be used to communicate with a controller 68 to control various functions of the incubator system 2, such as to control the microenvironment 14 and/or to control the function of the x-ray viewing panel 40, as is described herein. The digital display 54 also presents a variety of information regarding the incubator system 2 and elements thereof, the microenvironment 14, and/or the condition of the neonate 82.

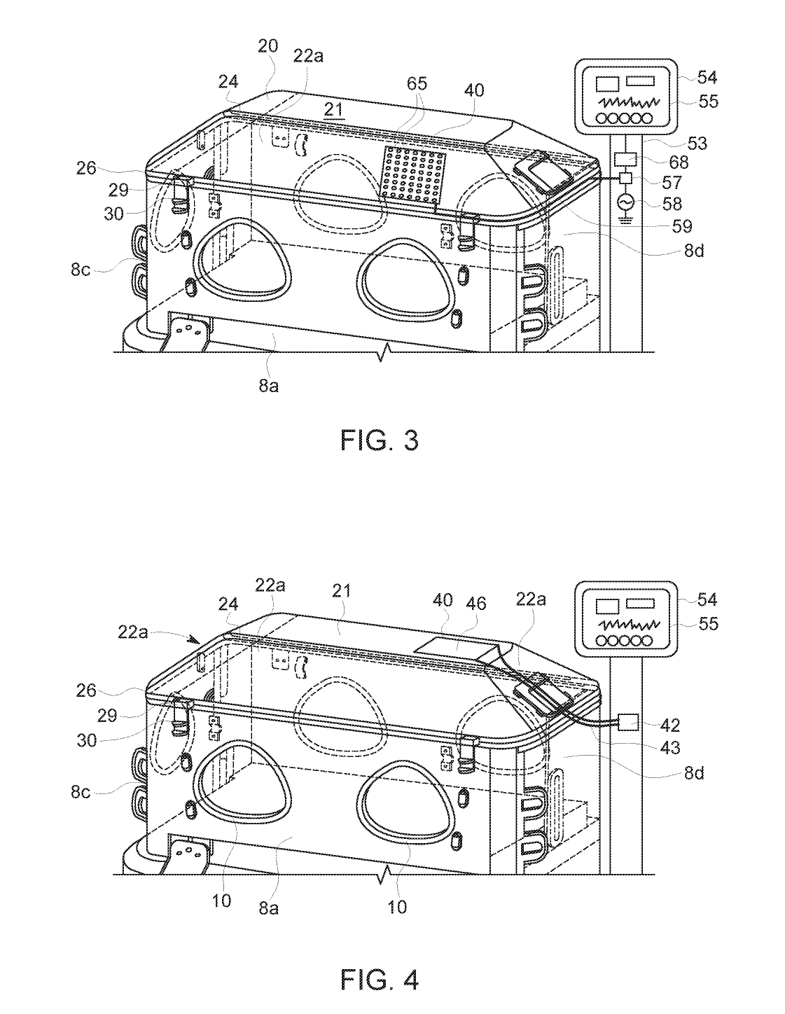

In various embodiments, examples of which are provided in FIGS. 3-7, the x-ray viewing panel 40 may be permanently fixed to and/or integrated into the material of the hood 20, or the x-ray viewing panel 40 may be a moveable element placeable on the hood 20 as needed by the clinician 80. In the embodiment of FIG. 3, the x-ray viewing panel 40 is illuminated by multiple LEDs 65 arranged in a matrix, or a grid-like array or configuration, such that they illuminate an area of the hood 20 comprising the x-ray viewing panel 40. The LEDs are powered by a power source 58 through a switch 57 controllable by a clinician 80 to turn on, or illuminate the x-ray viewing panel 40. The clinician would then place the x-ray film over the x-ray viewing panel. The matrix of LEDs 45 is provided on the angled side portion 22a of the hood 20. A conductor 59 connects between the switch 57 and the x-ray viewing panel 40 in order to conduct current from the power source 58 to the matrix of LEDs 65.

The matrix of LEDs 65 may be integrated into the material of the hood 20. For example, the hood 20 may be comprised of a transparent plastic material, and the matrix of LEDs 65 may be attached to or formed into the translucent hood. In such an embodiment, the x-ray viewing panel 40 may be translucent such that the clinician 80 can see the neonate 82 through the x-ray viewing panel when the LEDs 65 are not illuminated. In other embodiments, the x-ray viewing panel 40 may be comprised of a light diffusing material, such as an opaque material or a prismatic material that deflects the light from the LEDs 65. In still other embodiments, the hood 20 may be comprised of glass and the LEDs 65 may be attached to an internal surface of the hood 20, and the adjacent external surface of the hood 20 may have an etched surface in the glass or a light diffuser film placed over the glass to defuse the light from the LEDs. In still further embodiments, each LED 65 or groups or sections of LEDs 65 may be provided under a light diffusing cap or top that individually diffuses the light from each of the LEDs or groups of LEDs. In still other embodiments, the x-ray viewing panel 40 may be a separate device attached to the hood 20, such as to an exterior side of the hood or to an interior of the hood oriented to transmit the light through the hood 20. For example, the x-ray viewing panel 40 may be illuminated by a printed circuit board (PCB) comprising a grid of white LEDs. The PCB may be fixed to an exterior surface outside of the hood, or to an interior surface inside of the hood, or it may be integrated into the material of the hood.

In other embodiments, the x-ray viewing panel 40 and the matrix of LEDs 65 may be provided on the flat top side 21 of the hood 20. In the depicted embodiment having the matrix of LEDs 65 on the angled side portion 22a, the conductor 59 is oriented along the bottom edge 26 of the hood 20, where the hood meets the vertical walls 8a-8d. Thus, the conductor 59 is minimally visible and does not obstruct the clinician's ability to view the neonate 82 in the incubator system 2. The switch 57 may be provided anywhere on the incubator system 2 between the power source 58 and the light source 42 (e.g. matrix of LEDs 65). In the depicted embodiment, the control switch 57 is provided on the support 53 beside the canopy 6, which in the depicted embodiment holds the digital display 54. Accordingly, the switch 57 is conveniently located for a clinician to turn on and off the x-ray viewing panel 40, without being in a location where the clinician 80 might accidently bump it.

In another embodiment, exemplified in FIG. 2, the switch 57 may be provided on the hood 20 at a location adjacent to the x-ray viewing panel 40. In still other embodiments, the x-ray viewing panel 40, and specifically the light source 42, may be selectively illuminated via a graphical user interface 55 provided on the digital display 54. For example, the digital display 54 may be a touchscreen providing a touch input control for controlling illumination of the x-ray viewing panel 40. The graphical user interface 55 and digital display 54 may be communicatively connected to the controller 68, which correspondingly provides control signals to the switch 57 to turn on and off the LEDs 65.

In certain embodiments, especially where the x-ray viewing panel 40 is on the angled side portion 22a, the hood 20 may also be provided with a support shelf underneath the x-ray viewing panel 40 to support x-ray films, or alternatively with one or more clips on or around the x-ray viewing panel capable of holding the x-ray film in place. In still other embodiments, the clinician may be required to hold the x-ray film over the x-ray viewing panel 40 during viewing.

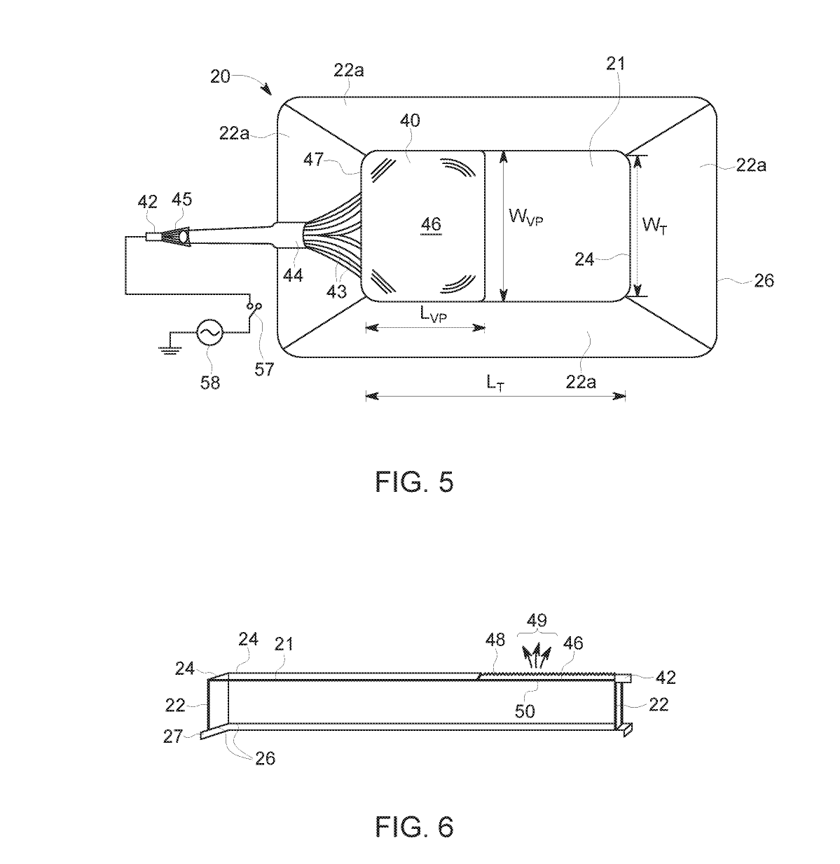

In other embodiments, examples of which are depicted in FIGS. 4-7, the light source 42 illuminating the x-ray viewing panel 40 may be adjacent to or remote from the x-ray viewing panel 40. In such an embodiment, the x-ray viewing panel 40 comprises a light diffuser 46 to diffuse and emit the light from the light source 42 across the length and width of the x-ray viewing panel 40. FIGS. 4 and 5 depict an embodiment where the light source 42 is remote from the x-ray viewing panel 40, where light from the light source 42 is conducted through optical fibers 43 to a light diffuser 46 which diffuses the light across the x-ray viewing panel 40. In certain embodiments, the light source 42 is connected to a light guide 45 which guides the light therefrom into the optical fibers 43.

The optical fibers 43 connecting the light source 42 to the light diffuser 46 create a flexible and moveable connector allowing the light diffuser 46 to be moved to any range of positions with respect to the light source 42. Thus, the light from the light source 42 does not need to be transmitted along a direct, straight path, as the optical fibers 43 can efficiently transmit the light from the light source 42 through bends and twists at various locations along the optical fibers 43. The optical fibers 43 may be, for example, end-emitting optical fibers, which may minimize the amount of light lost or emitted in transmission from the light source 42 to the light diffuser 46. Alternatively or additionally, the optical fibers 43 may be surrounded by a sheath 44, which is an opaque material that prevents any light from escaping. Such an embodiment may be beneficial to prevent light from the light source 42 from being undesirably directed toward the neonate 82 and thus disturbing him or her.

The light diffuser 46 may be of any construction or material that diffuses light from the light source 42 across the length and width of the x-ray viewing panel 40. In one embodiment, the light diffuser 46 may be a thin panel, or sheet, of diffuser film that guides and emits light along its length. Such a light diffuser 46 may be a transparent or translucent wave guide made of glass, plastic, or other suitable transparent or translucent material, with deformations or disruptions therein that cause light rays entering the input edge 47 to be directed outward from the x-ray viewing panel 40 in the direction of the x-ray film. Various such light diffusing materials and elements are known and available in the art, which may include light deflecting elements created by cutting, molding, coating, forming, or otherwise causing deformations in the emitting surface 48 emitting the diffused light 49 (FIG. 6). For example, the emitting surface 48 may be mechanically or chemically etched to create a prismatic surface that emits light in various directions outwardly from the emitting surface. Additionally, a reflector 50 may be provided on the back side of the light diffuser 46 that prevents emission of the light out of the back surface of the x-ray viewing panel 40, thus preventing (or significantly reducing) the light from being shined on to the neonate 82. Likewise, the light diffuser may be surrounded by reflective edges that prevent transmission of the light out of the sides of the light diffuser 46, thus narrowing the emitted direction of the diffused light 49 in order to direct it away from the neonate 82 and toward the location of the x-ray film. In certain embodiments, the emitting surface may be formed into the flat top side 21 or the side portion 22 of the hood 20, such as by etching the prismatic emitting surface 48 into the exterior side of the hood 20, or by attaching a thin film over the exterior side of the hood 20 at the location of the x-ray viewing panel 40.

In certain embodiments, the x-ray viewing panel 40, including the light diffuser 46, may be a moveable piece placeable on or fixable to any range of positions on the hood 20. In other embodiments, the light diffuser 46 illuminating the x-ray viewing panel 40 may be integrated into and/or formed into the hood 20. The x-ray viewing panel may be variously sized in order to fit on the hood 20, such as on the flat top side 21 or angled side portion 22a.

FIG. 5 shows a top view of an exemplary hood 20 having an x-ray viewing panel 40 on the flat top side 21 thereof. The x-ray viewing panel 40 occupies a portion of the top side 21, and in certain embodiments may be moveable, as described above. The flat top side 21 has a width W_{T} and a length L_{T}. The x-ray viewing panel 40 is comprised of a light diffuser 46 having a width Wᵥₚ that is less than or equal to the width W_{T} of the top side, and a length Lᵥₚ that is less than or equal to the length L_{T} of the top side 21. In the depicted embodiment, the width Wᵥₚ of the light diffuser 46 is approximately equal to the width W_{T} of the top side 21, while the length Lᵥₚ of the light diffuser 46 is significantly less than the length L_{T} of the to top side 21. In certain embodiments, the light diffuser 46 may be moveable along the length L_{T} of the flat top side 21 by the clinician 80, or may be moveable off the flat top side 21 onto one or more of the angled side portions 22 as is convenient for the clinician 80. To provide just one explanatory embodiment, the light diffuser 46 may have a width Wᵥₚ of 20 cm and length Lᵥₚ of 20 cm, and the flat top side 21 of the hood may have an approximate width W_{T} of 20 cm and a length L_{T} of 40 cm.

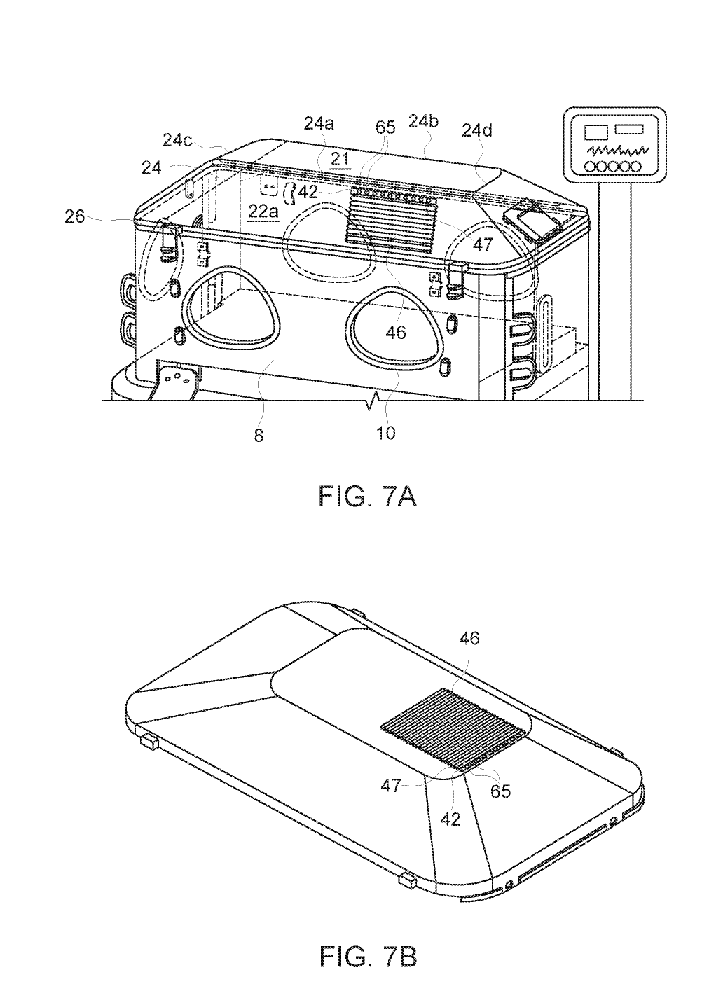

In certain embodiments the light source 42 may be provided immediately adjacent to the input edge 47 of the light diffuser 46. FIGS. 7A and 7B depict exemplary embodiments having a light source 42 comprised of a band, or strip, of LEDs 65 that transmit light into the input edge 47 of the light diffuser 46. The band or strip of LEDs may be preferably arranged on an edge 24, 26 of the hood 20, such as the top edge 24 surrounding the flat top side 21 and/or the bottom edge 26 of the hood 20. Thereby, the light source 42 of LEDs can be positioned to optimally direct light into the light diffuser 46. For example, the LEDs 65 may be unidirectional bright LEDs arranged on the top edge 24 and directing light into the light diffuser 46, which may be on an angled side portion 22a or the flat top side 21 of the hood 20 as exemplified in the Figures. For example, the array, or strip of LEDs 65 may be integrated into the edge 24, 26 of the hood, or may be removable elements attached to the edge 24, 26.

In certain embodiments, the hood 20 having the x-ray viewing panel 40, and possibly also containing the light source 42, may be configured to be removable from the incubator system 2. In the embodiments exemplified at FIGS. 3-7, the hood 20 removably connects to the vertical walls 8 of the canopy 6. In such embodiments, connectors 29 on a lip portion 27 around the bottom edge 26 of the hood 20 mate with corresponding connectors 30 on the vertical walls 8 (e.g., FIG. 3). Thereby, the hood 20 can be easily removed from the side walls 8, such as for cleaning, maintenance, or replacement. For example, in embodiments where the LEDs 65 of the light source are integrated into the hood 20, the hood may be removed for maintenance or replacement should one or more of the LEDs fail. This feature also provides the ability to create a customizable system, where a hood 20 comprising an x-ray viewing panel 40 and light source 42 can be added to an incubator system 2 for housing a neonate 82 for which x-rays will comprise part of the treatment plan provided by clinicians 80.

In still other embodiments, the x-ray viewing panel 40 and light source 42 may be a digital display connected to or incorporated into the hood 20. The digital display, such as the digital display 54 exhibited in FIG. 1, may be operated in an x-ray viewing mode where it is illuminated in a bright and solid color, such as in a bright white color, to provide an illuminated surface that serves as the x-ray viewing panel 40. For example, the GUI 55 may be operated to instruct the controller 68 to operate the digital display 54 in the x-ray viewing mode. The touchscreen of the digital display may then also be operated to exit the viewing mode, such as by touching a particular location on the screen or touching the screen in a predefined pattern. The digital display 54 may be mounted at any location on the canopy 6, such as to a location on the hood 20 or on any of the vertical walls 8a-8d. For example, the digital display may be mounted at location of the x-ray viewing panel 40 shown in FIGS. 1 and 2. In still other embodiments, the digital display 54 may be mounted at any location on the incubator system 2, such as on a support 53 extending from the pedestal 61, base 60 or platform 4. In certain embodiments, a shelf, clip, or other support means may be provided to hold the x-ray film over the digital display 54 when the digital display is operated in the x-ray viewing mode to provide the x-ray viewing panel 40. Such operation of the digital display 54 in the x-ray viewing mode may be an alternative to or in addition to the x-ray viewing panel 40 embodiments described above, such as the array of LEDs 65 and/or the light diffuser 46.

This written description uses examples to disclose the invention, including the best mode, and also to enable any person skilled in the art to make and use the invention. Certain terms have been used for brevity, clarity and understanding. No unnecessary limitations are to be inferred therefrom beyond the requirement of the prior art because such terms are used for descriptive purposes only and are intended to be broadly construed. The patentable scope of the invention is defined by the claims, and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

We claim:

1. A neonatal incubator system comprising:
a platform for supporting a neonate;
a canopy defining an area above the platform, the canopy having at least two vertical walls extending generally perpendicularly with respect to the platform and a hood that extends above the platform;
an x-ray viewing panel on the hood of the canopy, the x-ray viewing panel illuminable to view x-ray film; and
a light source that illuminates the x-ray viewing panel.

2. The neonatal incubator system of claim 1, wherein the x-ray viewing panel is a light diffuser that diffuses light from the light source.

3. The neonatal incubator system of claim 2, wherein the light diffuser is a flexible sheet that removably attaches to an exterior of the hood.

4. The neonatal incubator system of claim 3, wherein the light source is one or more unidirectional LEDs connected to the light diffuser by one or more flexible optical fibers that allow movement of the light diffuser to any angle with respect to the light source.

5. The neonatal incubator system of claim 2, wherein the hood of the canopy is comprised of transparent glass or plastic, and wherein the light diffuser is a light diffusing surface formed into the glass or plastic of the hood.

6. The neonatal incubator system of claim 5, wherein the hood includes a flat top side that is generally horizontal, wherein the light source is on an edge of the flat top side.

7. The neonatal incubator system of claim 6, wherein the light diffuser is on the flat top side.

8. The neonatal incubator system of claim 6, wherein hood includes at least one angled side connecting between the flat top side and one of the vertical walls, wherein the angled side is at an angle greater than 90° and less than 180° from the vertical wall, wherein the x-ray viewing panel is on the angled side.

9. The neonatal incubator system of claim 6, wherein the light source is a plurality of unidirectional LEDs positioned on the edge of the flat top side.

10. The neonatal incubator system of claim 9, wherein the light source is formed into the hood, and wherein the hood removably connects to the vertical walls.

11. The neonatal incubator system of claim 1, wherein the light source is comprised of a plurality of LEDs arranged in a matrix.

12. The neonatal incubator system of claim 1, wherein the x-ray viewing panel is on an angled side of the hood of the canopy, the angled side extending above the platform at an angle greater than 0° and less than 90° from horizontal.

13. The neonatal incubator system of claim 1, wherein the hood includes a flat top side that is generally horizontal, wherein the x-ray viewing panel is on the flat top side.

14. The neonatal incubator system of claim 1, wherein the x-ray viewing panel is a digital display operated by a controller in an x-ray viewing mode where the digital display illuminates to provide the x-ray viewing surface.

15. A hood for a canopy of an incubator, the canopy enclosing an area above a platform that supports a neonate, the canopy having four vertical walls extending generally perpendicularly with respect to the platform, the hood comprising:
a flat top side that is generally horizontal and extends above the platform, the flat top side surrounded by an edge;
four side portions connecting between the edge of the flat top side and a connection lip configured to removably connect to the vertical walls of the canopy; and
an x-ray viewing panel, the x-ray viewing panel illuminable by a light source to view x-ray film.

16. The hood of claim 15, wherein the x-ray viewing panel comprises a light diffuser on an exterior surface of the hood and the light source comprises a plurality of LEDs on the hood.

17. The hood of claim 16, wherein the plurality of LEDs are on the edge of the flat top side of the hood and are positioned to project light into the light diffuser, which is positioned on either the flat top side or on one of the four side portions of the hood.

18. The hood of claim 16, wherein at least one of the four side portions is angled, and wherein the x-ray viewing panel is on the angled side portion.

19. The hood of claim 16, wherein the x-ray viewing panel is on the flat top side.

20. The hood of claim 15, wherein the x-ray viewing panel is a flexible light diffuser sheet removably attached to one of the flat top side or one of the four side portions of the hood.
